(19) United States
(12) Patent Application Publication
(10) Pub. No.: US 2024/0079194 A1
(43) Pub. Date: Mar. 7, 2024

(54) ACTUATION SYSTEM WITH A TEMPERATURE-CONTROLLED ACTUATION MATERIAL

(71) Applicant: Eaton Intelligent Power Limited, Dublin (IE)

(72) Inventors: Avadhoot Anil Kittur, Pune (IN); Ajay Chidambaram Pillai Swornalatha, Nagercoil (IN)

(21) Appl. No.: 18/235,554

(22) Filed: Aug. 18, 2023

Related U.S. Application Data
(60) Provisional application No. 63/404,211, filed on Sep. 7, 2022.

(51) Int. Cl. H01H 83/20

(52) U.S. Cl. CPC H01H 83/20; H01H 2083/206

(57) ABSTRACT

A switching system includes: a switch including an ON state and an OFF state; and an actuator. The actuator includes: an actuation system including an actuation material that has a temperature-controllable spatial extent; a control system configured to adjust the temperature of the actuation material to control the spatial extent of the actuation material; and a driving assembly coupled to the actuation system. The driving assembly moves in response to a change in the spatial extent of the actuation material to thereby change the state of the switch.

### CROSS-REFERENCE TO RELATED APPLICATION

This application claims the benefit of U.S. Provisional Application No. 63/404,211, filed on Sep. 7, 2022, and titled ACTUATION SYSTEM WITH A TEMPERATURE-CONTROLLED ACTUATION MATERIAL, which is incorporated herein by reference in its entirety.

### TECHNICAL FIELD

This disclosure relates to an actuation system with a temperature-controlled actuation material. The actuation system may be used to control the state of a switch in an electrical apparatus such as a capacitor switch.

### BACKGROUND

A switchable electrical apparatus is an electrical apparatus that has two stable states, a first state in which electrical current may flow through a switch in the electrical apparatus, and a second state in which electrical current cannot flow the switch. The electrical apparatus is used in an alternating current (AC) power system.

### SUMMARY

In one aspect, a switching system includes: a switch including an ON state and an OFF state; and an actuator. The actuator includes: an actuation system including an actuation material that has a temperature-controllable spatial extent; a control system configured to adjust the temperature of the actuation material to control the spatial extent of the actuation material; and a driving assembly coupled to the actuation system. The driving assembly moves in response to a change in the spatial extent of the actuation material to thereby change the state of the switch.

Implementations may include one or more of the following features.

The actuation material may be a shape memory alloy. The actuation system also may include a rod; the actuation system may be coupled to the assembly at the rod; and the actuation material may extend axially along the rod. The actuation material may be wound about the rod. The actuation system also may include an attachment member disposed on the rod, the attachment member may be mounted to a support at a mounting point; and a first end of the actuation material may be affixed to the rod; a second end of the actuation material may be affixed to the attachment member; and the rod may move relative to the attachment member and may rotate about the mounting point in response to the change in the spatial extent of the actuation material. The rod may include a slot; and the driving assembly may include a pin that is received in the slot and couples the driving assembly to the actuation assembly. The driving assembly also may include a clutch coupled to the pin and to a drive shaft, and, in these implementations, the drive shaft rotates in response to rotation of the clutch, and the change in the spatial extent of the actuation material rotates the clutch to thereby change the state of the switch.

The switch may include: a first electrical contact, and a second electrical contact configured to move relative to the first electrical contact. In these implementations, the switch is in the ON state when the first electrical contact and the second electrical contact are in electrical contact with each other, and the switch is in the OFF state when the first electrical contact and the second electrical contact are not in electrical contact with each other; and the system also may include: a housing that at least partially encloses the switch; and a switch actuator in the housing and coupled to the drive shaft. The switch actuator may be configured to move the second contact relative to the first contact to change the state of the switch in response to rotation of the drive shaft. The actuation system may be external to the housing, and, in these implementations, the drive shaft extends through the housing.

The switching assembly also may include a temperature control configured to heat or cool the actuation material in response to a command from the control system. The temperature control may include a current source electrically connected to the actuation material; and the control system may be configured to control the current source to thereby control the spatial extent of the actuation material.

The actuation material may have a compressed state and an expanded state; the actuation material may transform into the compressed state in response to the temperature of the actuation material reaching a first transformation temperature; and the actuation material may transform into the expanded state in response to the temperature of the actuation material reaching a second transformation temperature.

The switch may be part of an electrical apparatus, and the electrical apparatus may be a capacitor switch.

The switching assembly also may include an interlock configured to hold the switch in the OFF state.

In another aspect, an actuator for an electrical apparatus includes: an actuation system including an actuation material that has a temperature-controllable spatial extent; a control system configured to adjust the temperature of the actuation material to control the spatial extent of the actuation material; and a driving assembly coupled to the actuation system. The driving assembly moves in response to a change in the spatial extent of the actuation material to thereby move a movable contact in the electrical apparatus to change a state of a switch in the electrical apparatus.

Implementations may include one or more of the following features.

The actuation material may be a shape memory alloy. The actuation system also may include a rod; the actuation system may be coupled to the assembly at the rod; and the shape memory alloy may be a wire that extends axially along the rod and is wound about the rod. The driving assembly may include: a clutch; a crank coupled to the clutch, the crank including: a body; a tip; and a latch pin that extends from the tip. The latch pin may be configured to interact with an interlock to hold the switch in the electrical apparatus in an OFF state. The actuator also may include a second actuation material. The second actuation may be attached to the latch pin and may be configured to move the latch pin to release the latch pin from the interlock during a closing operation that transitions the switch to an ON state.

In another aspect, a control system includes: one or more electronic processors; and a machine-readable medium including instructions for opening the switch that, when executed, control a temperature control device to increase the temperature of the actuation material to compress the actuation material in at least one dimension to thereby cause a moveable contact of the switch to separate from a stationary contact of the switch such that the switch opens.

Implementations of any of the techniques described herein may be a system, a switching system, an actuator, a control system, a method, or executable instructions stored on a machine-readable medium. The details of one or more implementations are set forth in the accompanying drawings and the description below. Other features will be apparent from the description and drawings, and from the claims.

### DRAWING DESCRIPTION

FIG. 1 is a block diagram of an example of a system that includes an electrical apparatus and an actuator that controls a state of a switch in the electrical apparatus.

FIG. 2 is a block diagram of an example of a switch.

FIG. 3A is a perspective block diagram of an example of a switching system.

FIG. 3B is a side cross-sectional block diagram of the switching system of FIG. 3A.

FIG. 4A is a block diagram of an example of an actuator.

FIG. 4B is a block diagram of an example of a switching system that includes the actuator of FIG. 4A.

FIG. 4C is a cross-sectional view of an example of an attachment member taken along the line 4C-4C′ of FIG. 4A.

FIG. 4D is a side view of an example of a latch pin.

FIGS. 5A and 5B show the actuator of FIG. 4A during an opening operation.

FIGS. 5C and 5D show the actuator of FIG. 4A during a closing operation.

### DETAILED DESCRIPTION

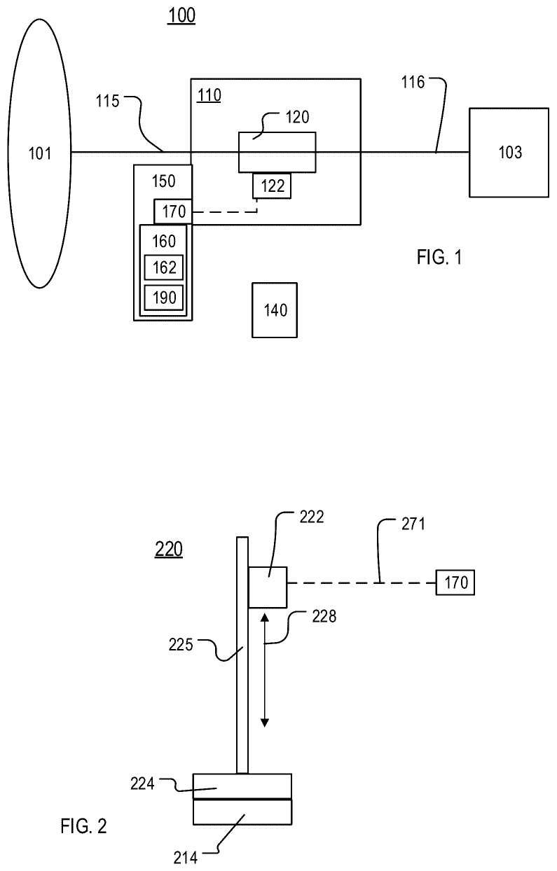

FIG. 1 is a block diagram of system 100 that includes an electrical apparatus 110 and actuator 150 that controls a state of a switch 120 in the electrical apparatus 110. The actuator 150 includes an actuation system 160 that is coupled to a driving assembly 170. The driving assembly 170 is coupled to a switch actuator 122 that drives a movable contact of the switch 120 to thereby change the state of the switch 120.

As discussed in greater detail below, the actuation system 160 includes an actuation material 162 that has a temperature-dependent or temperature-controllable spatial extent in at least one dimension. The actuation material 162 may be a shape memory alloy, a memory metal, a memory alloy, a smart alloy, and/or a smart metal. Changing the spatial extent of the actuation material 162 moves the driving assembly 170, and the motion of the driving assembly 170 actuates the switch actuator 122. In this way, changing or controlling the spatial extent of the actuation material 162 also may change or control the state of the switch 120. The actuation system 160 also includes a temperature control 190 that controls the temperature of the actuation material 162. The temperature control 190 is controlled by a control system 140. For example, the control system 140 may activate and/or deactivate the temperature control 190 based on user input and/or a pre-determined schedule. The control system 140 is shown as being separate from the switch 120 and the actuator 150. However, the control system 140 may be implemented as part of the switch 120 or as part of the actuator 150. The temperature control 190 may be, for example, a current source that provides a direct current (DC) electrical current to the actuation material 162 to control the temperature of the material 162.

Using the actuation material 162 results in the actuation system 160 being smaller, less complex, easier to maintain, lower cost, and/or lighter than legacy actuation systems. Furthermore, the actuation system 160 includes fewer components than legacy actuation systems. For example, legacy actuation systems for driving the switch 120 include additional components, such as, for example, a crank-rocker mechanism that converts rotary motion to oscillatory motion, a gear motor that provides the rotary motion, and a cam-follower mechanism for controlling the movement of the rocker during a switching operation. On the other hand, the actuation system 160 lacks such components and instead controls the temperature of the actuation material 162 to move the driving assembly 170 and transition the state of the switch 120.

Before discussing the actuation system 160 in greater detail, an overview of the system 100 is provided. The switch 120 is electrically connected to a first power line 115 and a second power line 116. The first power line 115 connects the electrical apparatus 110 to an alternating current (AC) power grid 101. The second power line 116 connects the electrical apparatus 110 to a load 103. The switch 120 is configured to repeatedly transition between an opened state and a closed state. When the switch 120 is open, the first power line 115 and the second power line 116 are not connected and the load 103 is disconnected from the AC power grid 101. When the switch 120 is closed, the first power line 115 and the second power line 116 are connected and the load 103 is electrically connected to the AC power grid 101.

The electrical apparatus 110 may be any type of device that can be used in the AC power grid 101. The electrical apparatus 110 may be an electrically operated oil switch for switching capacitive and/or inductive currents, a capacitor switch, a transformer, or a regulator, just to name a few. A single phase is shown in FIG. 1, but the electrical apparatus 110 may be a multi-phase device. For example, the electrical apparatus 110 may be a three-phase device. The first and second power lines 115, 116 may be any type of medium that is capable of conducting electricity. For example the power lines 115, 116 may be transmission lines, distribution lines, wires, and/or electrical cables, just to name a few.

The AC power grid 101 is a three-phase power grid that operates at a fundamental frequency of, for example, 50 or 60 Hertz (Hz). The power grid 101 includes devices, systems, and components that transfer, distribute, generate, and/or absorb electricity. For example, the AC power grid 101 may include, without limitation, generators, power plants, electrical substations, transformers, renewable energy sources, transmission lines, reclosers and switchgear, fuses, surge arrestors, combinations of such devices, and any other device used to transfer or distribute electricity. The electrical apparatus 110 may be connected to any device in the power grid 101.

The AC power grid 101 may be low-voltage (for example, up to 1 kilovolt (kV)), medium-voltage or distribution voltage (for example, between 1 kilovolts (kV) and 35 kV), or high-voltage (for example, 35 kV and greater). The switch 120 may be rated to switch AC currents having a peak magnitude between, for example, 60 and 200 Amperes(A), up to 200 A, between 150 A and 300 A, or between 200 A and 400 A. These current values are provided as examples, and the switch 120 may be configured for use in applications in which larger or smaller AC currents flow in the switch 120.

The power grid 101 may include more than one sub-grid or portion. For example, the power grid 101 may include AC micro-grids, AC area networks, or AC spot networks that serve particular customers. These sub-grids may be connected to each other via switches and/or other devices to form the grid 101. Moreover, sub-grids within the grid 101 may have different nominal voltages. For example, the grid 101 may include a medium-voltage portion connected to a low-voltage portion through a distribution transformer. All or part of the power grid 101 may be underground.

The load 103 may be any device that uses, transfers, or distributes electricity in a residential, industrial, or commercial setting, and the load 103 may include more than one device. For example, the load 103 may be a motor, an uninterruptable power supply, a capacitor, a power-factor correction device (such as a capacitor bank), or a lighting system. The load 103 may be a device that connects the electrical apparatus 110 to another portion of the power grid 101. For example, the load 103 may be a recloser or switchgear, a transformer, or a point of common coupling (PCC) that provides an AC bus for more than one discrete load. The load 103 may include one or more distributed energy resources (DER). A DER is an electricity-producing resource and/or a controllable load. Examples of DER include, for example, solar-based energy sources such as, for example, solar panels and solar arrays; wind-based energy sources, such as, for example wind turbines and windmills; combined heat and power plants; rechargeable sources (such as batteries); natural gas-fueled generators; electric vehicles; and controllable loads, such as, for example, some heating, ventilation, air conditioning (HVAC) systems and electric water heaters.

FIG. 2 is a block diagram of a switch 220. The switch 220 is an example of the switch 120, and the switch 220 may be used in the electrical apparatus 110 instead of the switch 120. The switch 220 includes a movable contact 224 and a stationary contact 214. The movable contact 224 can be moved relative to the stationary contact 214 by a switch actuator 222, which is controlled by the driving assembly 170. The driving assembly 170 is coupled to the switch actuator 222 by a linkage 271 (shown in a dashed line style). The linkage 271 is any type of linkage capable of transmitting commands from the driving assembly 170 to the switch actuator 222. For example, the linkage may be a mechanical linkage, such as a shaft, or an electronic linkage that communicates electronic commands or electrical signals from the driving assembly 170 to the switch actuator 222.

In the example of FIG. 2, the switch actuator 222 is coupled to and drives a movable actuation device (for example, a rod) 225 along an axis labeled 228. The movable contact 224 is at an end of the movable actuation device 225. The switch actuator 222 is any type of device or mechanism that may be driven to move the movable actuation device 225 along the axis 228 between two stable positions that each correspond to a stable state of the switch 220. For example, the switch actuator 222 may be a motor, springs, a cam assembly, or a combination of such devices.

The first stable state of the switch 220 is a closed or ON state in which the movable contact 224 is in contact with a stationary contact 214, as shown in FIG. 2. The second stable state of the switch 220 is an open or OFF state in which the contacts 224 and 214 are electrically disconnected from each other. In the ON state, current may flow through the switch 220. In the OFF state, current cannot flow through the switch 220. To transition from the ON state to the OFF state, the switch actuator 222 drives the actuation device 225 along the axis 228 to separate the movable contact 224 from the stationary contact 214. To transition from the OFF state to the ON state, the switch actuator 222 drives the actuation device 225 in the opposite direction to join the movable contact 224 to the stationary contact 214 such that the contacts 224 and 214 are electrically connected.

The movable contact 224 and the stationary contact 214 are made of any type of electrically conductive material. For example, the contacts 214 and 224 may be made of a metal or a metal alloy. Examples of such materials include, without limitation, brass, copper, steel, and aluminum. The contacts 214 and 224 may include a combination of electrical conductive materials. In some implementations, the contacts 214 and 224 include a substrate of a non-metallic material that is coated with a metallic material such as brass or copper. The actuation device 225 is made of an electrically insulating material, such as, for example, an electrically insulating polymer, a ceramic, or a combination of insulating materials.

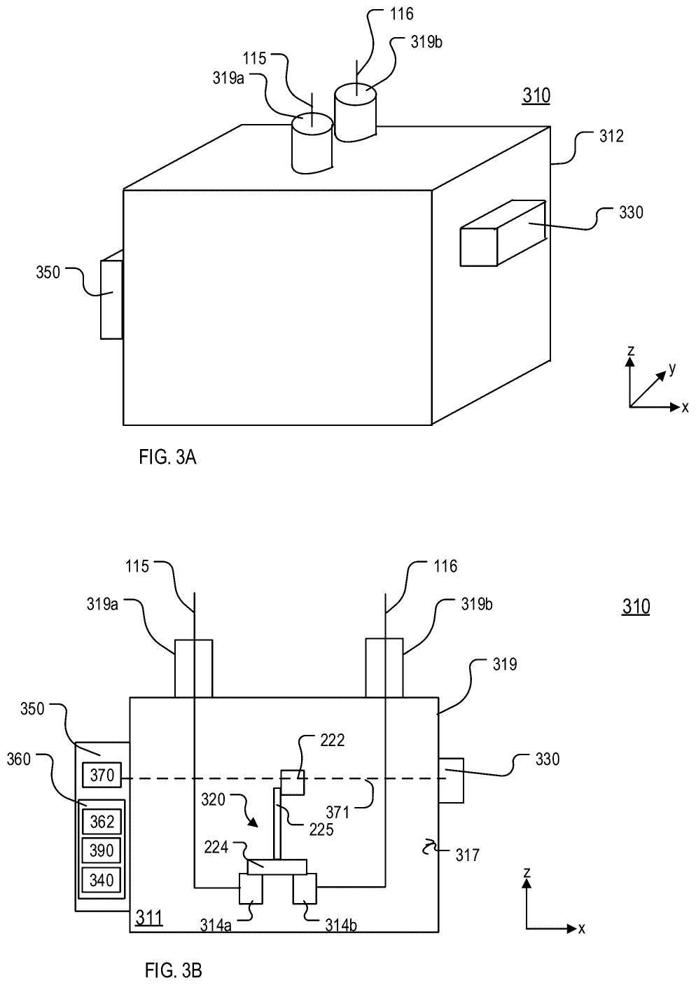

FIG. 3A is a perspective block diagram of an example of a switching system 310. The switching system 310 may be, for example, a capacitor switch. FIG. 3B is a side cross-sectional block diagram of the switching system 310 in the X-Z plane. The switching system 310 includes a housing or tank 312 that defines an interior region 311, and a switch 320 is in the interior region 311. The housing 312 is made of a rugged material that protects the switch 320 and other items in the interior region 311. For example, the housing 312 may be stainless steel, aluminum, or a ruggedized polymer material. The housing 312 may be sealed such that the interior region 311 is impervious to fluid ingress. The interior region 311 may include an electrically insulating fluid, for example, oil or a synthetic dielectric fluid.

The interior region 311 also contains stationary contacts 314a and 314b. The stationary contacts 314a and 314b are discrete electrically conductive contacts that are separated from each other and are electrically connected only when the movable contact 224 is in contact with the contacts 314a and 314b. The stationary contacts 314a and 314b are mounted to an interior structure 317. The interior structure 317 may be, for example, an interior wall of the housing 312 or a shelf in the interior region 311. The stationary contacts 314a and 314b are fixed to the structure 317 such that the stationary contacts 314a and 314b do not move. For example, the stationary contacts 314a and 314b may be bolted to the structure 317, attached to the structure 317 with an adhesive, and/or welded or brazed to the structure 317. The stationary contacts 314a and 314b are made with an electrically conductive material. For example, the stationary contacts 314a and 314b may be metal, a metal alloy, or a substrate coated with a metallic material. The stationary contacts 314a and 314b are electrically isolated from the housing 312 and other components in the interior region 311.

The stationary contact 314a is electrically connected to the first power line 115, and the stationary contact 314b is electrically connected to the second power line 116. The switching system 310 also includes bushings 319a and 319b. The bushings 319a and 319b extend from an exterior of the housing 312 and are made of an electrically insulating material such as, for example, ceramic or a polymer. The first power line 115 passes through the bushing 319a, and the second power line 116 passes through the bushing 319b.

An actuator 350 that includes an actuation system 360 to control the state of the switch 320 is mounted to an exterior of the housing 312. The actuation system 360 includes an actuation material 362 that has a temperature-controllable spatial extent in at least one dimension. The actuation material 362 is coupled to a driving assembly 370 that drives the switch actuator 222. Changing the extent of the actuation material 362 activates the driving assembly 370 and causes the state of the switch 320 to change.

The actuation system 360 also includes a temperature control 390 and a control system 340 that controls or commands the temperature control 390. The temperature control 390 is any type of device that is capable of controlling the temperature of the actuation material 362. For example, the temperature control 390 may be a current source that provides a relatively small direct current (DC) or non-time varying electrical current to the actuation material 362. When electrical current flows in the actuation material 362, the temperature of the material 362 increases. In this way, the temperature control 390 adjusts, changes, or controls the temperature of the material 362. The temperature control 390 may be implemented in other ways. For example, the temperature control 390 may be a heating and/or cooling element that heats and/or cools the actuation material 362 through direct or indirect thermal contact.

The control system 340 is used to command or control the temperature control 340. The control system 340 may be implemented as an electronic control that includes an electronic processing module and an electronic storage or memory. The electronic processing module includes one or more electronic processors, each of which may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC). The electronic storage is any type of electronic memory that is capable of storing data and instructions in the form of computer programs or software, and the electronic storage may include volatile and/or non-volatile components. The electronic storage and the processing module are coupled such that the processing module can access or read data from and write data to the electronic storage. Moreover, the electronic storage stores executable instructions, for example, as a computer program, logic, or software, that cause the processing module to perform various operations.

In implementations in which the control system 340 is an electronic control, the control system 340 controls the temperature control 390 with electronic signals and commands that cause the temperature control 340 to behave in a particular way. For example, the control system 340 may be pre-programmed to control the temperature control 390 to produce a particular output after the occurrence of an event, such as a fault or a pre-determined schedule. In implementations in which the temperature control 390 is a DC current source, the control system 340 may be pre-programmed to cause the temperature control 390 to output a DC current of a specific magnitude at a pre-determined time and for a pre-determined temporal duration.

The control system 340 may include an input-output interface that allows a user to control the temperature control 390 via the interface. The control system 340 may allow the user to control the temperature control 390 remotely. In some implementations, the control system 340 is a mechanical interface that is accessible from the exterior of the housing 312, such as, for example, a button, knob, and/or a manually operated toggle that is configured to activate or deactivate the temperature control 390 and/or to allow changes in the output of the temperature control 390.

The switching system 310 also includes an operating interface 330. The operating interface 330 is accessible from outside of the housing 312, and is operable to control the state of the switch 320. The operating interface 330 may be, for example, a handle, rod, or a button that is configured to be operated by a human operator. The operating interface 330 may be configured to be operated directly by the human operator, for example, by the operating grasping or otherwise manually manipulating the operating interface 330. Additionally or alternatively, the operating interface 330 may be configured for remote operation, electronic operation, motor operation, and/or configured for indirect operation by an operator, for example, by an operator who manipulates the operating interface 330 with a hot stick.

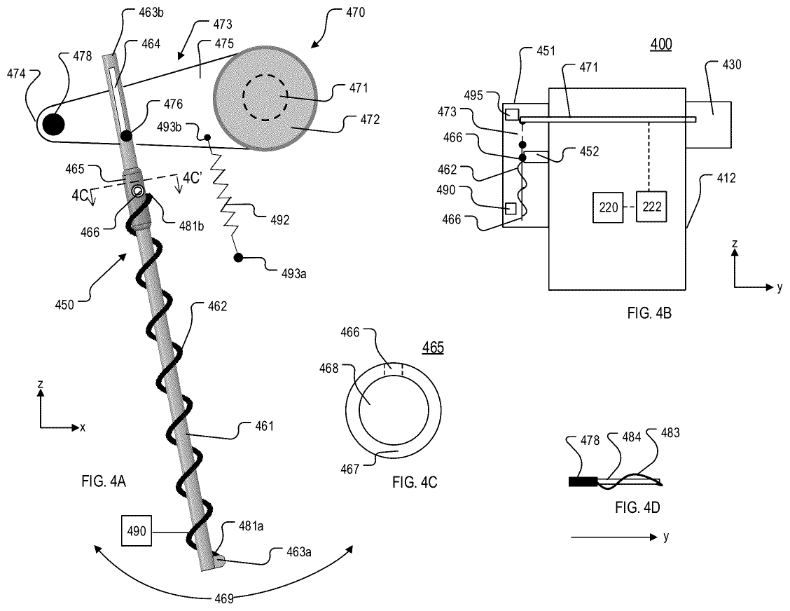

FIG. 4A is a block diagram of an example of an actuator 450. The actuator 450 is another example implementation of the actuator 150 (FIG. 1). FIG. 4B is a block diagram of a switching system 400 that includes the actuator 450 and the switch 220. The actuator 450 is in a housing 451. The switch 220 is in a housing 412 that is distinct from the housing 451. The actuator 450 includes an actuation system 460 and a driving assembly 470 that is coupled to the actuation system 460. The actuation system 460 includes an actuation material 462 that has a temperature-controllable spatial extent. As discussed below, changing the spatial extent of the actuation material 462 also moves the driving assembly 470 and changes the state of the switch 220.

The actuation system 460 also includes a rod 461 that extends from a first end 463a to a second end 463b. The rod 461 is substantially cylindrical and includes an opening 464 near the end 463b. The actuation system 460 also includes an attachment member 465 on the rod 461. The actuation material 462 is a flexible wire made of a two-way shape-memory alloy that is wound about an exterior of the rod 461. The actuation material 462 has a first end 481a and a second end 481b. The first end 481a is attached to the end 463a of the rod 461. The second end 481b is attached to the attachment member 465.

FIG. 4C is a cross-sectional view of the attachment member 465 taken along the line 4C-4C′. The attachment member 465 includes a sidewall 467 that defines an opening 468 that receives the rod 461. The attachment member 465 also includes an attachment region 466 on a portion of the sidewall 467. The attachment region 466 is an opening or recess in the sidewall 467 or a fastener on the sidewall 467 that attaches to a corresponding attachment mechanism at a fixed point 452 in the interior of the housing 451. In the example of FIGS. 4A and 4C, the attachment region 466 is an opening in the sidewall 467 that may be connected to the fixed point 452 by receiving a post, rivet, or fastener that is on the fixed point 452. The attachment region 466 is on one side of the attachment member 465 such that, when the attachment region 466 is attached to the fixed point 452, the attachment member 465 is also attached to the fixed point 452 but the rod 461 is able to slide axially in the opening 468. The connection between the attachment region 466 and the fixed point 452 also allows the rod 461 and the attachment member 465 to pivot at the fixed point 452 and move along an arc 469.

The spatial extent or shape of the actuation material 462 depends on the temperature of the material 462. The actuation material 462 compresses or becomes smaller when the material 462 reaches a first transformation temperature or compression temperature (Tc). The actuation material 462 remains in the compressed form until the temperature of the material 462 reaches a second transformation temperature or expansion temperature (Te). The material 462 retains its expanded shape until the transformation temperature (Tc) is reached again. In this way, the actuation material 462 has one of two shapes or extents depending on the temperature of the material 462. The actuation material 462 is wound around the exterior of the rod 461 in a helix and acts as a spring that is compressed when the actuation material 462 reaches the first transformation temperature (Tc) and expands when the actuation material 462 reaches the second transformation temperature (Te).

The actuation material 462 is also connected to a temperature control 490 that is governed by a control system such as the control system 140 (FIG. 1) or the control system 340 (FIG. 3). The temperature control 490 controls the temperature of the actuation material 462. For example, the temperature control 490 may be an electrical current source that provides a DC electrical current to the actuation material 462. The temperature of the actuation material 462 increases when it conducts electricity, thus, the temperature control 490 controls the extent of the actuation material 462. For example, by providing electrical current to the actuation material 462, changing the magnitude of the electrical current provided, and/or ceasing to provide electrical current to the actuation material 462, the temperature control 490 causes the actuation material 462 to expand, contract, or remain in its present shape.

The values of the expansion temperature (Te) and the compression temperature (Tc) depend on the composition and material characteristics of the actuation material 462. The composition of the actuation material 462 is selected such that the transformation temperatures (Tc) and (Te) are outside of the typical temperatures that exist in the interior of the housing 451. This ensures that changes in the spatial extent of the material 462 are intentional and are caused by the temperature control 490 rather than being caused by fluctuating environmental conditions in the 451. For example, in some implementations, the switching system 400 is designed to operate in temperatures between −50° C. and 50° C. or between −40° C. and 46° C. In these implementations, the transformation temperature (Tc) may be above 100° C. and the second transformation temperature (Te) is near or greater than 100° C. In yet another example, the transformation temperature (Tc) may be 100° C. and the second transformation temperature (Te) may be 95° C. The actuation material 462 may have transition temperatures other than the examples provided. The temperatures Te and Tc are different, and the second transformation temperature (Te) may be less than the transformation temperature (Te).

The actuation material 462 is any type of two-way shape-memory alloy. A specific example of the actuation material 462 is a binary equiatomic intermetallic compound that includes 49% nickel (Ni) and 51% titanium (Ti). The value of the transition temperatures (Te) and (Tc) may be adjusted by varying the relative amount of nickel and titanium. Other examples of shape memory alloys include alloys in various composition of nickel-titanium-cobalt (Ni—Ti—Co), nickel-titanium-copper (Ni—Ti—Cu). Additionally, copper-based alloys such as copper-aluminum-nickel (Cu—Al—Ni) and copper-zinc-aluminum (Cu-Zi-Al) that also exhibit 2-way shape memory effect may be used as the actuation material 462. The relative amount of the metal elements in the alloys may be varied to vary the values of the transition temperature (Te) and (Tc).

The actuation material 462 is also associated with a transition time (Tt), which is the time for the shape or extent of the material 462 to change after reaching the transition temperature Tc or Te. The transition time (Tt) may be, for example, less than 10 seconds (s), less than 5 s, less than 2 s, or between is and 4 s. The actuation material 462 may have a wire diameter of 1 millimeter (mm), 2 mm, 5 mm, greater than 1 mm, or less than 1 mm. The alloy composition, diameter, and/or length of the actuation material 462 also affect the transition time (Tt).

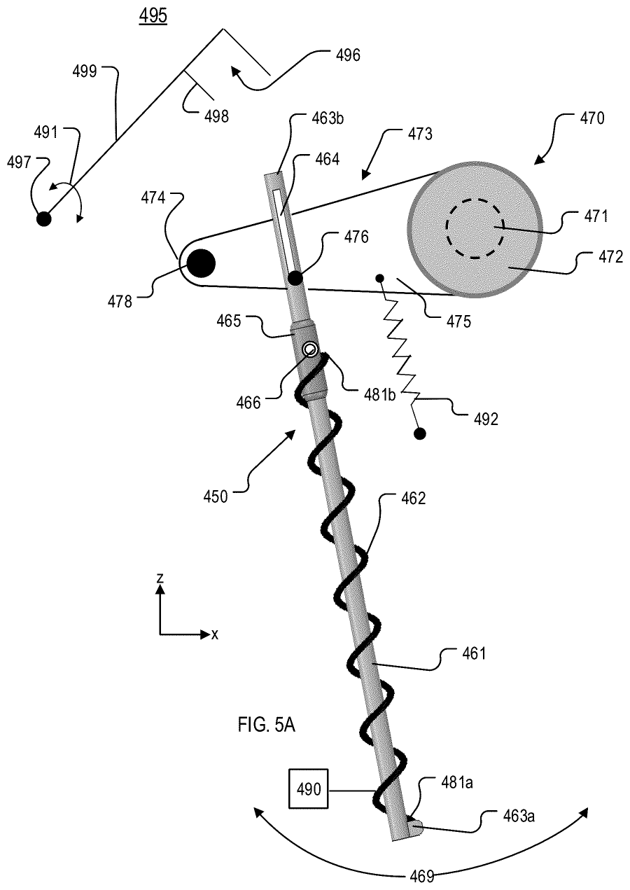

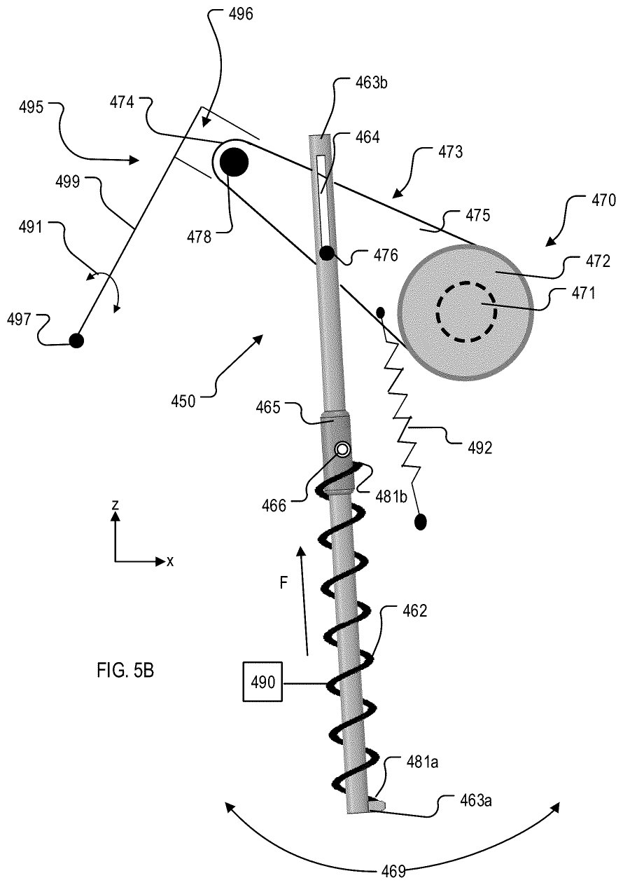

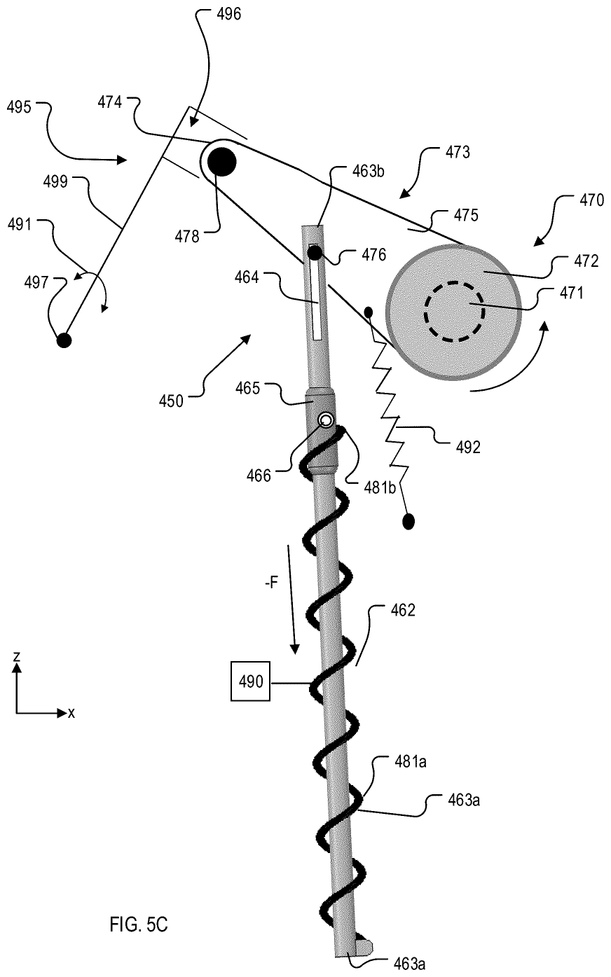

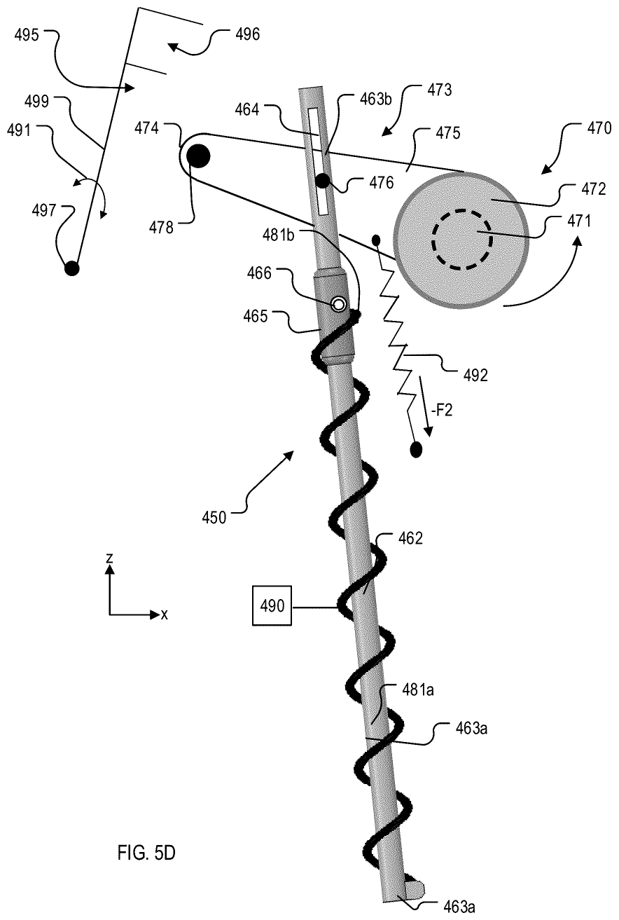

The drive assembly 470 includes a clutch 472 and a crank 473 that is coupled to the clutch 472. The crank 473 includes a body 475 that extends from the clutch 472 to a tip 474, and a latch pin 478 that extends in the —Y and/or Y direction (into and/or out of the page). FIG. 4D is a side view of the latch pin 478. The latch pin 478 is slidably connected to a pin rod 484 that extends along the Y axis and to a flexible device 483. The flexible device 483 is also connected to the pin rod 484. The flexible device 483 is any type of structure that is able to expand and contract. The flexible device 483 may be, for example, a shape memory alloy, a memory metal, a memory alloy, a smart alloy, and/or a smart metal. The flexible device 483 may be a wire made of the same material as the actuation material 462. When the flexible device 483 contracts, the latch pin 478 moves in the Y direction along the pin rod 484. When the flexible device 483 expands, the latch pin 478 moves in the —Y direction along the pin rod 483. The tip 474 and latch pin 478 interact with a latch 495 (or interlock 495) in the interior of the housing 451, as discussed further with respect to FIGS. 5A-5D.

The body 475 includes a pin 476 that extends from the body 475 in the —Y direction (out of the page) and is received in the opening 464 of the rod 461. The pin 476 and the opening 464 are sized such that the pin 476 may slide in the opening 464. The clutch 272 is also coupled to a shaft 471 that is coupled to the switch actuator 222. The shaft 471 is also connected to a manual operation interface 430.

The clutch 472 transmits the motion from the crank 473 to the drive shaft 471. The clutch 472 may be an electromagnetic (EM) clutch that includes armature and a drive shaft. In these implementations, the clutch 472 is actuated only when current flows in the armature, producing a magnetic field that pulls the armature against the drive shaft such that frictional force is generated. When electrical current does not flow in the armature, the armature is free to turn with the drive shaft. The purpose of using an electromagnetic (EM) clutch is that the transmission from the crank 473 to the drive shaft can be decoupled for manual operation of the interface 430.

In the example shown, the drive assembly 470 also includes a spring 492 that includes ends 493a and 493b. The end 493a is attached to the body 475, and the end 493b is attached to a structure (such as a wall) in the interior of the housing 451. The spring 492 is an ordinary spring and is not made of a shape memory alloy. The spring 492 may be used to transition the switch from the open state to the closed state, as discussed with respect to FIGS. 5C and 5D.

FIGS. 5A and 5B show the actuator 450, the drive assembly 470, and the latch 495 during an opening operation for the switch 220. FIGS. 5C and 5D show the actuator 450, the drive assembly 470, and the latch 495 during a closing operation for the switch 220. In the examples of FIGS. 5A-5D, the clutch 472 is an EM clutch. FIGS. 5A-5D also show additional details of the latch 495. The latch 495 is attached to the interior of the housing 451 at an attachment point 497. The latch 495 can move about the attachment point 497 along an arc 491. The latch 495 includes a body 499 and a latch slot 496 that extends from the body 499. The latch slot 496 receives the latch pin 478 and/or the tip 474 to hold the body 475 in a particular position.

FIG. 5A shows the actuator 450 and the drive assembly 470 when the switch 220 is closed and prior to initiation of the opening operation. When the switch is closed, the contacts 214 and 224 (FIG. 2) are electrically connected. The actuation material 462 and the spring 492 are in a relaxed state and the temperature control 490 does not provide electrical current to the actuation material 462. The clutch 472 may be de-magnetized to allow for manual operation of the switch 220 via the manual operation interface 430 (FIG. 4B).

FIG. 5B shows the actuator 450 and drive assembly 470 shortly after the opening operation is initiated. To initiate the opening operation, the temperature control 490 is activated to provide electrical current to the actuation material 462. Electrical current flows in the actuation material 462, causing the temperature of the actuation material 462 to rise. The actuation material 462 becomes compressed (as shown in FIG. 5B) when the temperature of the material 462 reaches the first transformation temperature (Tc). When the material 462 compresses it generates a force F and the ends 481a and 481b of the material 462 move toward each other, causing the rod 461 to rotate clockwise (looking into the page) along the arc 469 and causing the rod 461 to slide in the direction of the force F relative to the attachment member 465. As the rod 461 moves, the edge of the opening 464 pushes the pin 476 in the direction of the force F and rotates the body 475 and the shaft 471 in the clockwise direction (looking into the page). The tip 474 and the latch pin 478 are held in the latch slot 496. The spring 492 becomes extended as the body 475 rotates in the clockwise direction.

The clockwise rotation of the shaft 471 actuates the switch actuator 222 to move the actuator 225 (FIG. 2) in the Z direction to separate the movable contact 224 from the stationary contact 214 such that the contacts 224 and 214 are no longer electrically connected. When the contacts 224 and 214 are electrically disconnected, the switch 220 is open and the opening operation is complete.

The temperature control 490 only provides current to the actuation material 462 during an actuation event. After the opening operation is complete, the temperature control 490 no longer provides electrical current to the actuation material 462 and the actuation material 462 begins to cool. For example, the control system 340 (FIG. 3B) may command the temperature control 490 to stop providing electrical current to the actuation material 462 after the opening operation is complete. The latch pin 478 remains in the latch slot 496 such that the rod 461 remains in position even though the actuation material 462 expands when the temperature of the material 462 reaches the second transformation temperature (Te).

FIGS. 5C and 5D show a closing operation of the switch 220 that transitions the switch 220 from an open state to a closed state. FIG. 5C shows the actuator 450 and drive assembly 470 shortly after the initiation of the closing operation. At the initiation of the closing operation, the switch 220 is open, the spring 492 is extended, the tip 474 is in the latch slot 496, and no electrical current is provided to the actuation material 462. The actuation material 462 is in the expanded state, and FIG. 5C shows the material 462 in the expanded state. The expanded actuation material 462 applies a force—F toward the end 463a (in the direction indicated by the arrow) to the attachment member 465 and the rod 461 moves axially along the direction of the force—F. The pin 476 engages with the upper edge of the opening 464 and pulls the body 475 in the direction of the force—F, causing the clutch 472 and shaft 471 to rotate in the counterclockwise direction (looking into the page).

Referring also to FIG. 5D, the flexible device 483 contracts such that the latch pin 478 slides along the pin rod 484 (FIG. 4D) in the Y direction and out of the latch slot 496, thereby releasing the body 475 and crank 473 from the latch 495. In implementations in which the flexible device 483 is a shape memory alloy, the flexible device 483 is compressed by the control system 340 (FIG. 3B) causing the temperature control 490 to supply electrical current to the flexible device 483 such that the flexible device 483 is heated to the compression temperature (Tc) associated with the particular material used for the flexible device 483.

After the latch 495 releases the crank 473, the clutch 472 and shaft 471 continue to rotate in the counterclockwise direction, and the spring 492 compresses and applies a spring force—F2 to the body 475, causing the crank 473, clutch 472, and shaft 471 to continue to rotate in the counterclockwise direction and pulling the crank 473 to its original position (as shown in FIG. 5A). The rotation of the shaft 471 causes the switch actuator 222 (FIG. 2) to move the actuator 225 along the axis labeled 228 until the movable contact 224 is electrically connected to the stationary contact 214. When the movable contact 224 is electrically connected to the stationary contact 214, the switch 220 is closed and the closing operation is complete. The actuation material 462 remains in the expanded state until it is intentionally heated again by commanding the temperature control 490 to provide the electric current to the actuation material 462. Thus, the actuation system, 460 does not require power while the switch 220 is in the closed state.

The force F (FIG. 5B) is a force that is sufficient to rotate the shaft 471 in the clockwise direction and open the switch 220. The force—F (FIG. 5D) is a force that is sufficient to rotate the shaft 471 in the counterclockwise direction, with the spring 492 providing additional force to complete the closing process. The magnitude of the force F and the force—F may be increased or decreased by adjusting the properties of the actuation material 462 to suit the application. The properties include, for example, the diameter of the wire and the chemical composition of the material 462. For example, the magnitude of the forces F and —F may be about 1 kilogram (kg) for a Ni—Ti wire that has a diameter of 1 mm.

These and other implementations are within the scope of the claims.

What is claimed is:

1. A switching system comprising:
a switch comprising an ON state and an OFF state; and
an actuator comprising:
an actuation system comprising an actuation material that has a temperature-controllable spatial extent;
a control system configured to adjust the temperature of the actuation material to control the spatial extent of the actuation material; and
a driving assembly coupled to the actuation system, wherein the driving assembly moves in response to a change in the spatial extent of the actuation material to thereby change the state of the switch.

2. The switching system of claim 1, wherein the actuation material is a shape memory alloy.

3. The switching system of claim 2, wherein the actuation system further comprises a rod;
the actuation system is coupled to the assembly at the rod; and the actuation material extends axially along the rod.

4. The switching system of claim 3, wherein the actuation material is wound about the rod.

5. The switching system of claim 3, wherein the actuation system further comprises an attachment member disposed on the rod, the attachment member mounted to a support at a mounting point; and wherein
a first end of the actuation material is affixed to the rod; a second end of the actuation material is affixed to the attachment member; and the rod moves relative to the attachment member and rotates about the mounting point in response to the change in the spatial extent of the actuation material.

6. The switching system of claim 5, wherein the rod comprises a slot; and the driving assembly comprises a pin that is received in the slot and couples the driving assembly to the actuation assembly.

7. The switching assembly of claim 6, wherein the driving assembly further comprises a clutch coupled to the pin and to a drive shaft; the drive shaft rotates in response to rotation of the clutch; and the change in the spatial extent of the actuation material rotates the clutch to thereby change the state of the switch.

8. The switching assembly of claim 7, wherein the switch comprises: a first electrical contact, and a second electrical contact configured to move relative to the first electrical contact; and wherein the switch is in the ON state when the first electrical contact and the second electrical contact are in electrical contact with each other, and the switch is in the OFF state when the first electrical contact and the second electrical contact are not in electrical contact with each other; and the system further comprises:
a housing that at least partially encloses the switch; and
a switch actuator in the housing and coupled to the drive shaft, wherein the switch actuator is configured to move the second contact relative to the first contact to change the state of the switch in response to rotation of the drive shaft.

9. The switching assembly of claim 8, wherein the actuation system is external to the housing, and the drive shaft extends through the housing.

10. The switching assembly of claim 1, further comprising a temperature control configured to heat or cool the actuation material in response to a command from the control system.

11. The switching assembly of claim 10, wherein the temperature control comprises a current source electrically connected to the actuation material; and the control system is configured to control the current source to thereby control the spatial extent of the actuation material.

12. The switching assembly of claim 1, wherein the actuation material comprises a compressed state and an expanded state; the actuation material transforms into the compressed state in response to the temperature of the actuation material reaching a first transformation temperature; and the actuation material transforms into the expanded state in response to the temperature of the actuation material reaching a second transformation temperature.

13. The switching assembly of claim 1, wherein the switch is part of an electrical apparatus, and the electrical apparatus is a capacitor switch.

14. The switching assembly of claim 1, further comprising an interlock configured to hold the switch in the OFF state.

15. An actuator for an electrical apparatus, the actuator comprising:
an actuation system comprising an actuation material that has a temperature-controllable spatial extent;
a control system configured to adjust the temperature of the actuation material to control the spatial extent of the actuation material; and
a driving assembly coupled to the actuation system, wherein the driving assembly moves in response to a change in the spatial extent of the actuation material to thereby move a movable contact in the electrical apparatus to change a state of a switch in the electrical apparatus.

16. The actuator of claim 15, wherein the actuation material is a shape memory alloy.

17. The actuator of claim 16, wherein the actuation system further comprises a rod; the actuation system is coupled to the assembly at the rod; and the shape memory alloy is a wire that extends axially along the rod and is wound about the rod.

18. The actuator of claim 17, wherein the driving assembly comprises:
a clutch;
a crank coupled to the clutch, the crank comprising: a body; a tip; and a latch pin that extends from the tip, wherein the latch pin is configured to interact with an interlock to hold the switch in the electrical apparatus in an OFF state.

19. The actuator of claim 18, further comprising a second actuation material, wherein the second actuation is attached to the latch pin and is configured to move the latch pin to release the latch pin from the interlock during a closing operation that transitions the switch to an ON state.

20. A control system comprising:
one or more electronic processors; and
a machine-readable medium comprising instructions for opening the switch that, when executed, control a temperature control device to increase the temperature of the actuation material to compress the actuation material in at least one dimension to thereby cause a moveable contact of the switch to separate from a stationary contact of the switch such that the switch opens.
